(19) United States
(12) Patent Application Publication
(10) Pub. No.: US 2008/0005439 A1
(43) Pub. Date: Jan. 3, 2008

(54) Information processing system and method of connection between equipments

(75) Inventor: Akifumi Matsukuma, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/802,561

(22) Filed: May 23, 2007

(30) Foreign Application Priority Data
May 24, 2006 (JP) 2006-143620

(51) Int. Cl. G06F 13/00

(52) U.S. Cl. 710/302

(57) ABSTRACT

An information processing system includes an I/O equipment, a control equipment and a relay equipment. The I/O equipment allows an I/O card to be mounted or removed in an operation, controls the I/O card based on a control message, and generates a state message indicating a state of said I/O card. The control equipment outputs said control message to the I/O equipment in response to the state message. The relay equipment relays the control message and the state message based on a configuration data indicating a connection relation between the I/O equipment and the control equipment.

### TECHNICAL FIELD

The present invention relates to an information processing system in which a hot plug can be used, and a method of connection between equipments.

### BACKGROUND ART

A connection to allow a part to be removed and added from and to an apparatus without turning off power supply of the apparatus is called a hot plug. For example, a hot plug request for removing the part from the apparatus is issued to a hot plug controller for controlling the hot plug. The hot plug controller informs the removal request of the part to an operating system (OS) by use of an interrupt. In response to the request, the operating system (OS) performs a removing process of the part and instructs the hot plug controller to perform a process of a power control to the part. When the hot plug controller completes the power control process for the part, the removal of the part can be allowed.

When the removal of the part is performed without performing the above processes (Surprise Remove), the hot plug controller detects the removal of the part and requests an interrupt. The operating system (OS) instructs the hot plug controller to perform a process of a power control to the part.

As mentioned above, hot plug devices which allow a part to be removed and added without turning off the power supply are increasing, and exchanging of parts is called a hot swapping. For example, Japanese Laid Open Patent Publication (JP-P2003-150409A) discloses an exclusive server management card with a hot plug function in a compact Peripheral Component Interconnect (cPCI) in a server system. This server system includes a plurality of print circuit assemblies and a management card. The plurality of print circuit assemblies includes at least one processor card. The management card is connected to the plurality of print circuit assemblies and exclusively performs monitoring and management of an operation of the server system, including monitoring and management of on-line inserting and removing of the print circuit assembly.

A disk array device which can be connected to a host is disclosed in Japanese Laid Open Patent Publication (JP-P2005-234825A). The disk array device has a plurality of hard disk drive devices, an input and output controller, a plurality of paths, and a housing. The input and output controller controls inputting and outputting of data between the host and the hard disk drive devices. The plurality of paths connects the hard disk drive devices to the input and output controller. The housing stores the hard disk drive devices in units of equipments of the predetermined number. When hard disk drive devices are increased or decreased, this disk array device has a function of indicating the housing or other hard disk drive devices connected to paths different from a path connected to a hard disk drive device to be increased or decreased. In addition, when a group of the predetermined number of the hard disk drive devices is increased, other hard disk drive device connected to a path different from a path connected to a hard disk drive device selected among inactivate hard disk drive devices.

Additionally, Japanese Laid Open Patent Publication (JP-P2005-509213A) disclosed a technique of a system management of a server system having a server blade carrier mounted with a plurality of server blades which can be removed. Each blade has a blade service controller possible to perform a monitoring function and a management function in the blade. The carrier has at least one carrier service processor. The carrier service processor is connected to the blade service controller of the blade added to the carrier, provides a management function in higher level and transmits the management function between the blades.

In a sequential flow for the hot plug operation, communication of hot plug signals such as a hot plug request and a hot plug permission notice is required between the hot plug controller and the hot plug part. In related art, the communication is carried out by using an exclusive signal line for a hot plug signal between the hot plug part and the hot plug controller.

### SUMMARY

An exemplary object of the present invention is to provide an information processing system which performs a hot plug process adapted to a system configuration. In addition, an exemplary object of the present invention is to provide an information processing system with a simple configuration in which a hot plug signal is switched.

In an exemplary aspect of the present invention, an information processing system includes an I/O equipment configured to allow an I/O card to be mounted or removed in an operation, to control the I/O card based on a control message, and to generate a state message indicating a state of the I/O card; a control equipment configured to output the control message to the I/O equipment in response to the state message; and a relay equipment configured to relay the control message and the state message based on a configuration data indicating a connection relation between the I/O equipment and the control equipment.

In another exemplary aspect of the present invention, a connecting method in an information processing system which comprises an I/O equipment configured to allow an I/O card to be mounted or removed in an operation, and a control equipment configured to control the I/O card, is achieved by generating a state message indicating a state of the I/O card; by relaying the state message to the control equipment based on a configuration data indicating a connection between the I/O equipment and the control equipment; by generating a control message indicating a control signal for the I/O card based on the state message; and by relaying the control message to I/O equipment based on the configuration data.

In still another exemplary aspect of the present invention, an information processing system includes a network; an I/O equipment connected with the network, and configured to allow an I/O card to be mounted or removed in an operation, to control the I/O card based on a control message, and to generate a state message indicating a state of the I/O card; a control equipment connected with the network, and configured to output the control message to the I/O equipment in response to the state message; and a relay equipment connected with the network, and configured to relay the control message and the state message based on a configuration data indicating a connection relation between the I/O equipment and the control equipment.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram showing a configuration of a multi-housing information processing system according to a first exemplary embodiment of the present invention;

FIG. 2 is a sequence diagram showing a Hot-Add operation in the multi-housing information processing system in the first exemplary embodiment;

FIG. 3 is a sequence diagram showing a Hot-Remove operation in the multi-housing information processing system in the first exemplary embodiment;

FIG. 4 is a block diagram showing a configuration of a multi-path and multi-housing information processing system according to a second exemplary embodiment of the present invention;

FIG. 5 is a sequence diagram showing an operation of switching a path in the multi-path and multi-housing information processing system in the second exemplary embodiment;

FIG. 6 is a block diagram showing a configuration of a multi-housing and multi-host information processing system according to a third exemplary embodiment of the present invention;

FIG. 7 is a sequence diagram showing an operation of switching a system in the multi-housing and multi-host information processing system in the third exemplary embodiment;

FIG. 8 is a block diagram showing a configuration of a multi-housing information processing system according to a fourth exemplary embodiment of the present invention;

FIG. 9A is a sequence diagram showing an operation of one of subsystems in the multi-housing information processing system in the fourth exemplary embodiment;

FIG. 9B is a sequence diagram showing an operation of the other of the subsystems in the multi-housing information processing system in the fourth exemplary embodiment;

FIG. 9C is a sequence diagram showing an operation of one of subsystems in the multi-housing information processing system in the fourth exemplary embodiment;

FIG. 9D is a sequence diagram showing an operation of the other of the subsystems in the multi-housing information processing system in the fourth exemplary embodiment; and

FIG. 10 is a diagram showing an example of a table showing a system configuration according to the exemplary embodiments of the present invention.

### EXEMPLARY EMBODIMENTS

Hereinafter, a multi-housing information processing system according to exemplary embodiments of the present invention will be described in detail with reference to the attached drawings.

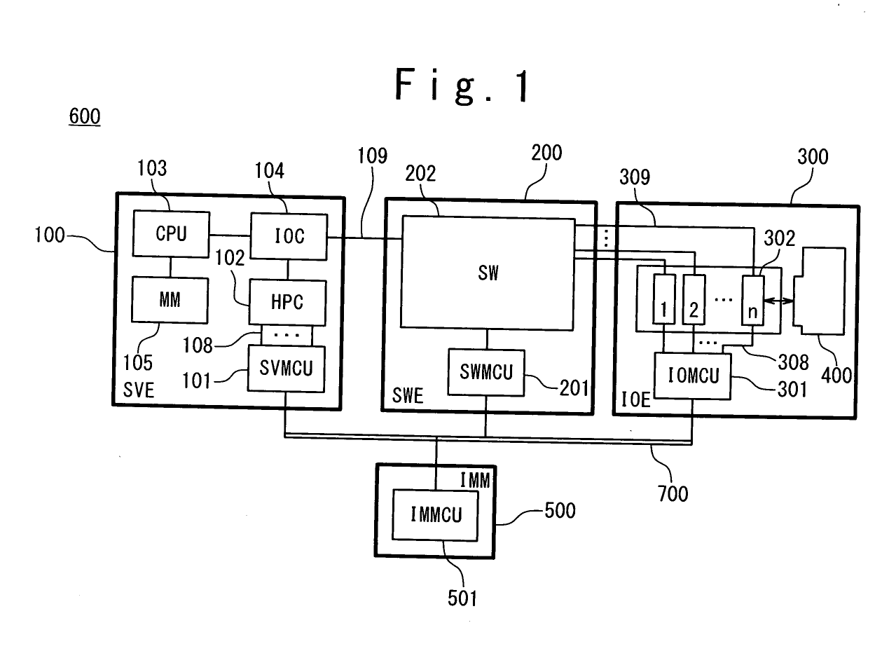

FIG. 1 is a block diagram showing a configuration of a multi-housing information processing system according to the first exemplary embodiment of the present invention. Referring to FIG. 1, the multi-housing information processing system 600 includes a host equipment (SVE) 100, a switching equipment (SWE) 200, an I/O equipment (IOE) 300, and an integrated management machine (IMM) 500, which are produced in different housings, respectively. These equipments and machine are connected to each other by an inter-equipment interface 700. A LAN (Local Area Network) such as the Ethernet (registered trademark) is exemplified as the inter-equipment interface 700 but other interfaces may be used.

The host equipment 100 includes a CPU (Central Processing Unit) 103, a host management control unit (SVMCU) 101, a memory (MM) 105, an I/O controller (IOC) 104, and a hot plug controller (HPC) 102. The CPU 103 performs programs stored in the memory 105. Basic functions used in an inputting and outputting function or in common are provided by an operating system (OS). The I/O controller 104 is driven based on the operating system and controls an inputting and outputting device to input and output data. The hot plug controller 102 performs power control of equipments for the hot plug and bus connection control on the basis of a hot plug signal group 108 inputted and outputted to and from the equipments for the hot plug. The hot plug controller 102 is controlled by the operating system (OS) through the I/O controller 104. The host management control unit 101 performs power control of the host equipment 100 and a failure process, and further sets a plug-in signal of a hot plug signal group 108 to the hot plug controller 102 to an assert or deassert state in response to an instruction from the integration management machine 500. In addition, when the hot plug controller 102 sets any of the hot plug signal group 108 to the assert or deassert state, the host management control unit 101 informs this as an event to the integration management machine 500.

The switching equipment 200 switches correspondence relations between a bus 109 connected to the I/O controller 104 of the host equipment 100 and a bus 309 connected to I/O card slots 302-1 to 302-n in the I/O equipment 300, by a switching mechanism (SW) 202. A switching management unit (SWMCU) 201 performs power control of the switching equipment 200 and failure processing, and further performs a connection control of the switching mechanism 202 in response to an instruction from the integrated management device 500. When switching failure occurs or a configuration of the switching mechanism 202 is changed, a switching management unit 201 informs the event to the integration management machine 500.

The I/O equipment 300 is connected to the host equipment 100 through the switching equipment 200. The I/O equipment 300 includes a card slot section having I/O card slots 302 (302-1 to 302-n) and an I/O management control unit (IOMCU) 301. The I/O management control unit 301 performs power control of the I/O equipment 300 and a failure process, and further sets any of the hot plug signal group 308 to the I/O card slots 302-1 to 302-n to an assert or deassert state in response to an instruction from the integration management machine 500. In addition, when the hot plug signal generated by an I/O card 400 is set to the assert or deassert state, the I/O device management unit 301 informs this as an event to the integration management machine 500. The hot plug signal group 308 for the I/O card slots 302 are connected to the I/O device management unit 301, and the bus 309 is connected to the switching equipment 200. When the I/O card 400 is mounted on arbitrary one of the I/O card slots 302, a plug-in signal of the hot plug signal group 308 is set to an assert state to indicate the mounting of the I/O card 400 to the concerned I/O card slot 302. A power control signal of the hot plug signal group 308 is supplied from a controller side, to instruct the power-on or power-off to the I/O card 400. When power is supplied to the I/O card 400, the I/O card 400 mounted on the concerned I/O card slot 302 can be accessed from the host equipment 100 through the switching equipment 200. Although a control a connected bus is required, a description about it will be omitted.

The integration management machine 500 includes an integrated management machine control unit (IMMCU) 501, and can mutually communicate with the host management control unit 101 of the host equipment 100, the switching management control unit 201 of the switching equipment 200, and the I/O management control unit 301 of the I/O equipment 300 through the LAN. The integration management machine control unit 501 performs operation management such as power management for whole system and failure processing, and further receives occurrence notices of hot plug events from the host management control unit 101, the switching management control unit 201, and the I/O management control unit 301 and instructs the host management control unit 101, the switching management control unit 201, and the I/O management control unit 301 to perform hot plug processes, if necessary.

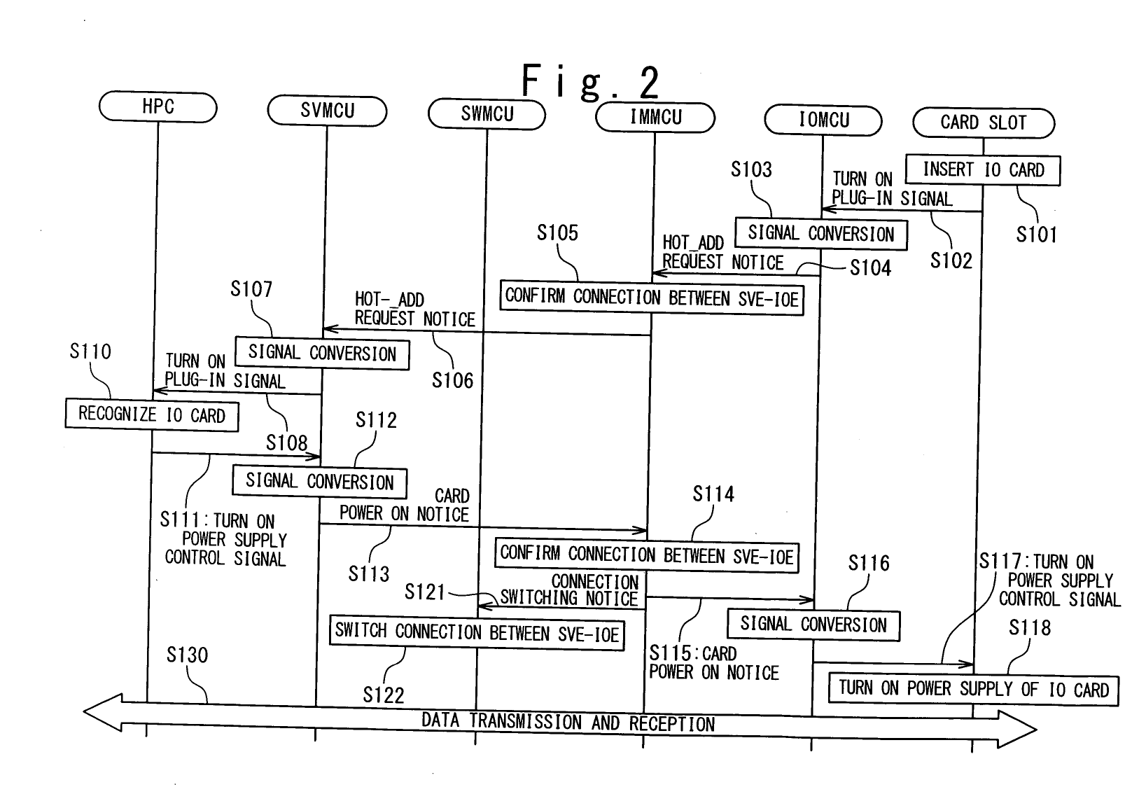

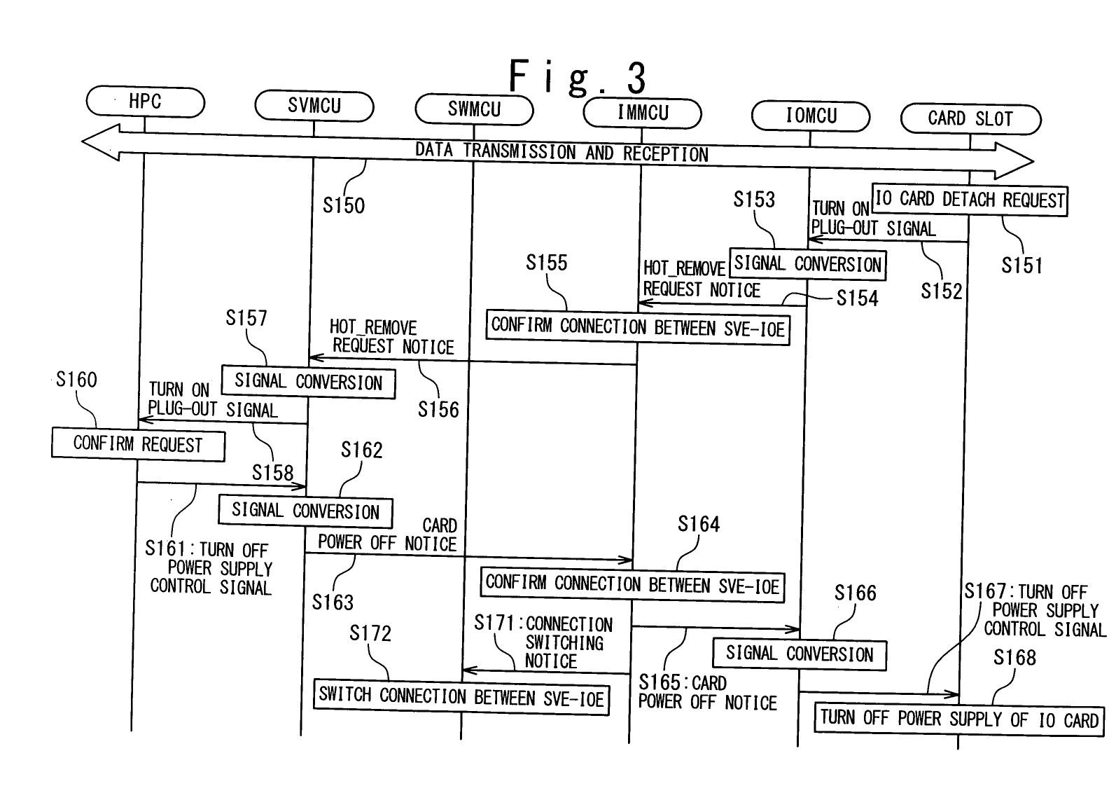

Referring to FIGS. 2 and 3, an operation of the information processing system according to this exemplary embodiment of the present invention when a hot plug event occurs will be described. At first, a Hot-Add operation in which the I/O card 400 is installed in a system by being mounted on the concerned I/O card slot 302 will be described with reference to a sequence chart shown in FIG. 2.

When the I/O card 400 is inserted into and mounted on the concerned I/O card slot 302 (step S101), a plug-in signal is set to an assert state as a hot plug signal of Hot-Add request from the I/O card 400. The plug-in signal indicates the assert state and is transferred to the I/O management control unit. 301 through an exclusive signal line (step S102).

When detecting that the plug-in signal is in the assert state, the I/O management control unit 301 converts the plug-in signal into a notice message of Hot-Add request (step S103). A data indicating a position of the concerned I/O card slot 302 on which the I/O card 400 is mounted, i.e., a card slot numbers 1 to n is added to this message. The I/O management control unit 301 transfers the notice message of Hot-Add request to the integration management machine control unit 501 through a LAN 700 (step 3106).

The integration management machine control unit 501 receives the notice message of Hot-Add request and confirms a connection relation between the host equipment 100 and the I/O equipment 300 based on the position of the concerned card slot added to the message (step S105). The integration management machine control unit 501 transfers the notice message of Hot-Add request to the host management control unit 101 through the LAN 700 (step S106).

The host management control unit 101 receives the notice message of Hot-Add request from the integration management machine control unit 501 and converts the notice message of Hot-Add request into electric signals (step S107). That is to say, the host management control unit 101 transmits the plug-in signal in the assert state to the hot plug controller 102 (step S108). When detecting that the plug-in signal is in the assert state, the hot plug controller 102 generates an interrupt to the operating system (OS) through the I/O controller 104.

The operating system (OS) changes a state of the concerned I/O card slot 302 managed by the hot plug controller 102 into a state in which the I/O card 400 is mounted. The operating system (OS) instructs the hot plug controller 102 to turn on power of the I/O card 400 mounted on the concerned I/O card slot 302 through the I/O controller 104 (step S110). In response to the instruction from the operating system (OS), the hot plug controller 102 sets a power control signal for the concerned I/O card slot 302 to the assert state (step S111).

When detecting that the hot plug controller 102 has asserted the power control signal, the host management control unit 101 converts it into a card power-on notice message (step S112). The host management control unit 101 informs the card power-on notice message to the integration management machine control unit 501 through the LAN 700 (step S113).

The integration management machine control unit 501 receives the card power-on notice message and confirms the connection relation between the host equipment 100 and the I/O equipment 300 (step S114). The integration management machine control unit 501 transfers the card power-on notice message to the I/O management control unit 301 through the LAN 700 (step S115). In addition, the integration management machine control unit 501 transfers a connection switch notice message to the switching management control unit 201 on the basis of the confirmed connection relation (step S121).

The I/O management control unit 301 receives the card power-on notice message, decodes or reads the message and performs signal conversion from the deassert state to the assert state of one of the hot plug signal group 308 corresponding to the concerned I/O card slot 302 on which the I/O card is mounted (step S116). That is to say, the I/O management control unit 301 sets the power control signal connected to the concerned I/O card slot 302 to the assert state (step S117). When the power control signal is set to the assert state, power is supplied to the concerned I/O card slot 302 so that the slot becomes valid, and the I/O card 400 can be utilized by the host equipment 100 (step S118).

On the other hand, the switching management control unit 201 receives the connection switching notice message and performs a connection control in the switching mechanism 202 to validate a connection between the concerned I/O card slot 302 and the host equipment 100 (step S122). Thereafter, the bus 109 and the bus 309 are connected to each other through the switching equipment 200, and transmission and reception of data are carried out between the I/O card 400 and the host device 100 (step S130).

Next, a Hot-Remove operation in which the I/O card 400 is removed from the concerned I/O card slot 302 to be separated from the system will be described with reference to a sequence chart shown in FIG. 3.

The transmission and reception of data is carried out between the I/O card 400 and the host device 100 through the switching equipment 200 (step S150). A remove request is generated on the I/O card 400 (step S151). A plug-out signal of the hot plug signal group 308 which is connected to the I/O management control unit 301 through the concerned I/O card slot 302 is set to the assert state (step S152).

The plug-out signal indicates a request of removing the I/O card 400 in the voltage level. When detecting that the plug-out signal is set to the assert state, the I/O management control unit 301 generates a Hot-Remove request notice message to indicate the removing request (step S153). The I/O management control unit 301 transmits the Hot-Remove request notice message to the integration management machine control unit 501 through the LAN 700 (step S154).

The integration management machine control unit 501 receives the Hot-Remove request notice message and confirms the connection relation between the host equipment 100 and the I/O equipment 300 based on a card slot position indicating the card slot for the I/O card 400 to be mounted and added to the message (step S155). The integration management machine control unit 501 transmits the Hot-Remove request notice message to the host management control unit 101 through the LAN 700 (step S156).

The host management control unit 101 receives the Hot-Remove request notice message from the integration management machine control unit 501 and converts the Hot-Remove request notice message into an electric signal (step S160), asserts a plug-out signal connected to the hot plug controller 102 (step S158). When detecting that the plug-out signal is in the assert state, the hot plug controller 102 generates an interrupt to the operating system (OS) through the I/O controller 104.

The operating system (OS) changes a state of the concerned I/O card slot 302 managed by the hot plug controller 102 into a state in which an I/O card is removed and instructs the hot plug controller 102 to stop the power supply to the I/O card 400 through the I/O controller 104 (step 5160). In response to the instruction from the operating system (OS), the hot plug controller 102 sets a power control signal to the concerned I/O card slot 302 to a deassert state (step S161).

When detecting that the hot plug controller 102 has deasserted the power control signal, the host management control unit 101 generates a card power-off notice message (step S162). The host management control unit 101 informs the card power-off notice message to the integration management machine control unit 501 through the LAN 700 (step S163).

The integration management machine control unit 501 receives the card power-off notice message and confirms the connection relation between the host equipment 100 and the I/O equipment 300 (step S164). After that, the integration management machine control unit 501 transmits the card power-off notice message to the I/O management control unit 301 through the LAN 700 (step S165). In addition, the integration management machine control unit 501 transmits the connection switching notice message to the switching management control unit 201 based on the confirmed connection relation (step S171).

The I/O management control unit 301 receives the card power-off notice message, decodes the message and performs signal conversion of a signal the hot plug signal group 308 corresponding to the concerned I/O card slot 302 from the deassert state to the assert state (step S166). That is to say, the I/O management control unit 301 deasserts a power control signal connected to the concerned I/O card slot 302 (step S167). When the power control signal is deasserted, power of the concerned I/O card slot 302 is turned off, and the I/O card 400 can be removed from the concerned I/O card slot 302 (step S168).

On the other hand, the switching management control unit 201 receives a connection switching notice message and performs the connection control of the switching mechanism 202 and invalidates a connection between the concerned I/O card slot 302 and the host equipment 100 (step S172). It should be noted that the I/O management control unit 301 may inform to the integration management machine control unit 501 through the LAN 700 that power of the concerned I/O card slot 302 is turned off and the concerned I/O card slot 302 become invalid. In that case, the integration management machine control unit 501 notifies to the switching management control unit 201 through the LAN 700 that the concerned I/O card slot 302 became invalid. If the switching management control unit 201 performs a connection control of the switching mechanism 202 when receiving this notice, switching of the switching equipment 200 can be assured.

As described above, in the multi-housing information processing system 600, the hot plug process can be realized without arranging signal lines exclusively for the hot plug signal group 308 between the host equipment 100 and the I/O card slots 302.

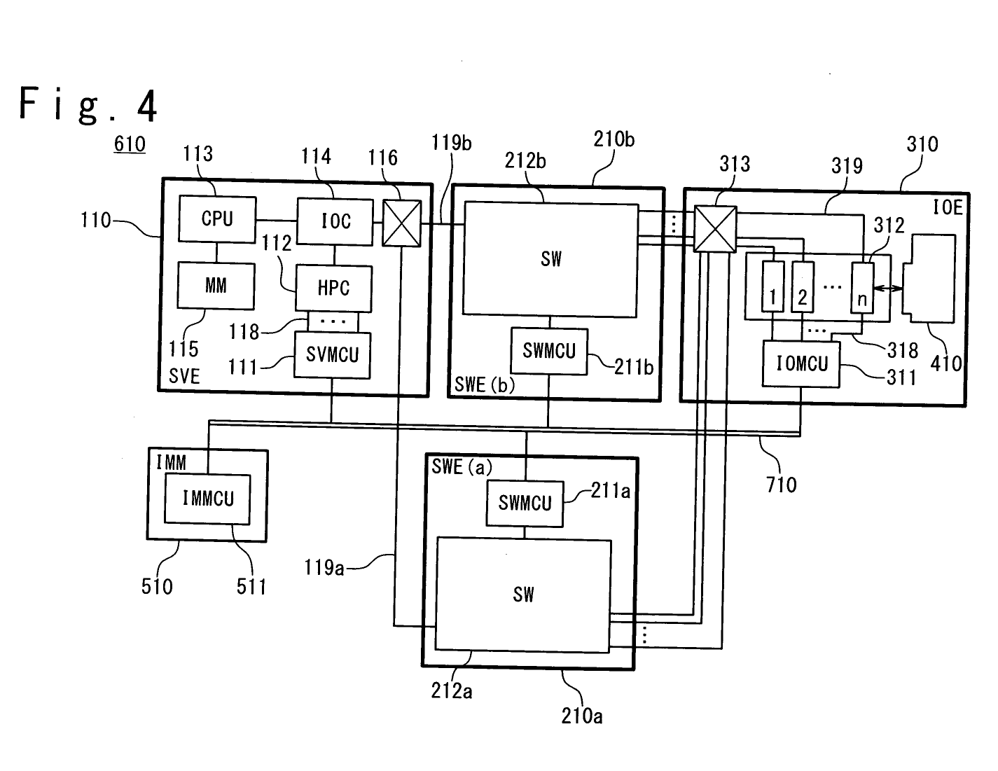

Referring to FIG. 4, the multi-housing information processing system according to the second exemplary embodiment will be described. FIG. 4 is a block diagram showing a configuration of a multi-path and multi-housing information processing system.

A switching equipment 210a and a switching equipment 210b are provided, to have a doubled configuration. Therefore, if a trouble in one switching equipment or a trouble of path in one switching equipment occurs, an operation can be allowed to be continued. The host equipment 110 and the I/O equipment 310 are connected to the switching equipment 210a and the switching equipment 210b and include switching units 116 and 313 for switching signal paths, respectively. Since other components are same as those of the units in the first exemplary embodiment shown in FIG. 1, the detailed description is omitted. The host equipment 110 includes a CPU 113, a host management control unit 111, a memory 115, an I/O controller 114, a hot plug controller 112, and a switching unit 116. The switching unit 116 switches a connection path to the I/O equipment 310 into the switching equipment 210a or the switching equipment 210b based on a control of the host management control unit 111.

The switching equipment 210a includes a switching management control unit 211a and a switching mechanism 212a, and the switching equipment 210b includes a switching management control unit 211b and a switching mechanism 212b. The I/O equipment 310 includes a card slot section having I/O card slots 312-1 to 312-n, an I/O management control unit 311, and the switching unit 313. The switching unit 313 switches a connection path to the host equipment 110 into the switching equipment 210a or the switching equipment 210b based on a control of the I/O management control unit 311. The host management control unit 111, the switching management control unit 211a, the switching management control unit 211b, and the I/O management control unit 311 communicate with each other through the LAN 710.

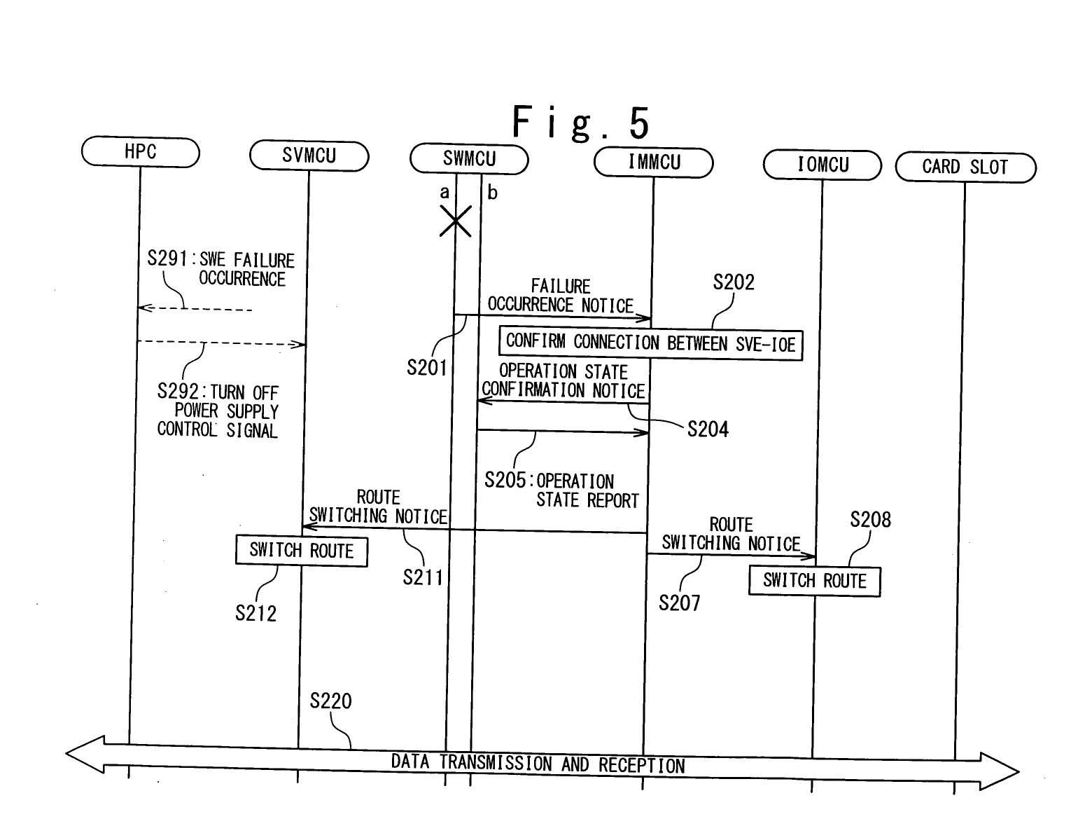

An operation when the switching equipment 210a becomes a failure state in a multi-path and multi-housing information processing system 610 will be described with reference to FIG. 5. When hot plug signal groups 118 and 318 are connected between the host equipment 110 and the I/O equipment 310 through the switching equipment 210a or 210b, the hot plug signal groups 118 and 318 are disconnected if a failure has occurred in the switching equipment 210a. As a result, the hot plug controller 112 built in the host equipment 110 detects “Surprise Remove” associated with the failure of the switching equipment 210a (step S291). The hot plug controller 112 detects this hot plug event, deasserts a power control signal in response to an instruction of the operating system (OS), turns off power of an I/O card 410, and deals with removing of the I/O card 410 (step S292). In the information processing system 610 having doubled signal paths, the I/O card 410 is still mounted on the I/O card slot 312. Therefore, by switching the switching units 116 and 313 into other paths, i.e., the switching equipment 210b side, an operation can be allowed to be continued without the hot plug process.

When any failure has occurred in the switching equipment 210a, the switching management control unit 211a informs the occurrence of the failure to the integration management machine control unit 511 by transmitting a failure occurrence notice message (step S201). The integration management machine control unit 511 confirms a connection relation between the host equipment 110 and the I/O equipment 310 based on a position where the failure has occurred (step S202). The integration management machine control unit 511 transmits a notice message for checking operation state to the switching management control unit 211b in order to check an operation of the switching operation 210b that is a different path between the host equipment 110 and the I/O equipment 310 (step S204). The switching management control unit 211b transmits an operation state notice message indicating that the switching mechanism 212b is normally operating (step 3205) When confirming that the continuation of the operation is allowed, the integration management machine control unit 511 transmits a path switching notice message to the host management control unit 111 and the I/O management control unit 311 for switching a path without instructing a hot plug process to the I/O card 410 (steps S211 and S207). The I/O management control unit 311 receives the path switching notice message, instructs the switching equipment 313 to switch a path and performs a switch failure process other than the hot plug process (for example, log collection) (step S208). In addition, the host management control unit 111 receives the path switching notice message, instructs the switching unit 116 to switch a path and performs a switch failure process other than the hot plug process (for example, log collection) (step S212). After that, a bus 119b and a bus 319 are connected by the switching equipment 211b between the host equipment 110 and the I/O equipment 310 and data is transmitted and received (step S220). Thus, an appropriate hot plug process in the multi-housing system having doubled paths can be easily realized.

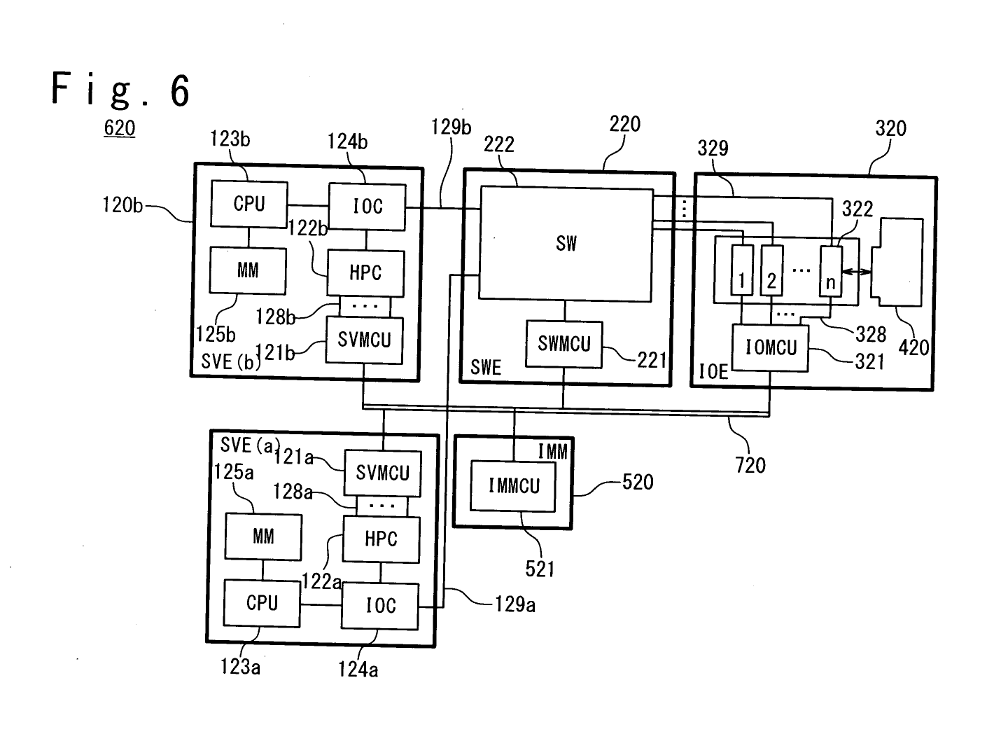

Next, referring to FIG. 6, a multi-housing information processing system according to a third exemplary embodiment will be described. FIG. 6 is a block diagram showing a configuration of a multi-housing and multi-host information processing system. A multi-housing and multi-host information processing system 620 includes a host equipment 120a and a host equipment 120b, a switching equipment 220, and an I/O equipment 320.

The multi-housing and multi-host information processing system 620 is configured to make it possible to use an arbitrary one of the I/O card slots 322 from the host equipment 120a and the host equipment 120b, respectively. The host equipment 120a is a current operation system and the host equipment 120b is a backup system. Since each component is same as that in FIG. 1, the detailed description is omitted. The current operation host equipment 120a includes a CPU 123a, a host management control unit 121a, a memory 125a, an I/O controller 124a, and a hot plug controller 122a. The backup host equipment 120b includes a CPU 123b, a host management control unit 121b, a memory 125b, an I/O controller 124b, and a hot plug controller 122b. The switching equipment 220 includes a switching mechanism 222 and a switching management control unit 221. The I/O equipment 320 includes a card slot section having I/O card slots 322-1 to 322-n and an I/O management control unit 321. The host management control unit 121a, the host management control unit 121b, the switching management control unit 221, and the I/O management control unit 321 communicate with each other through the LAN 720.

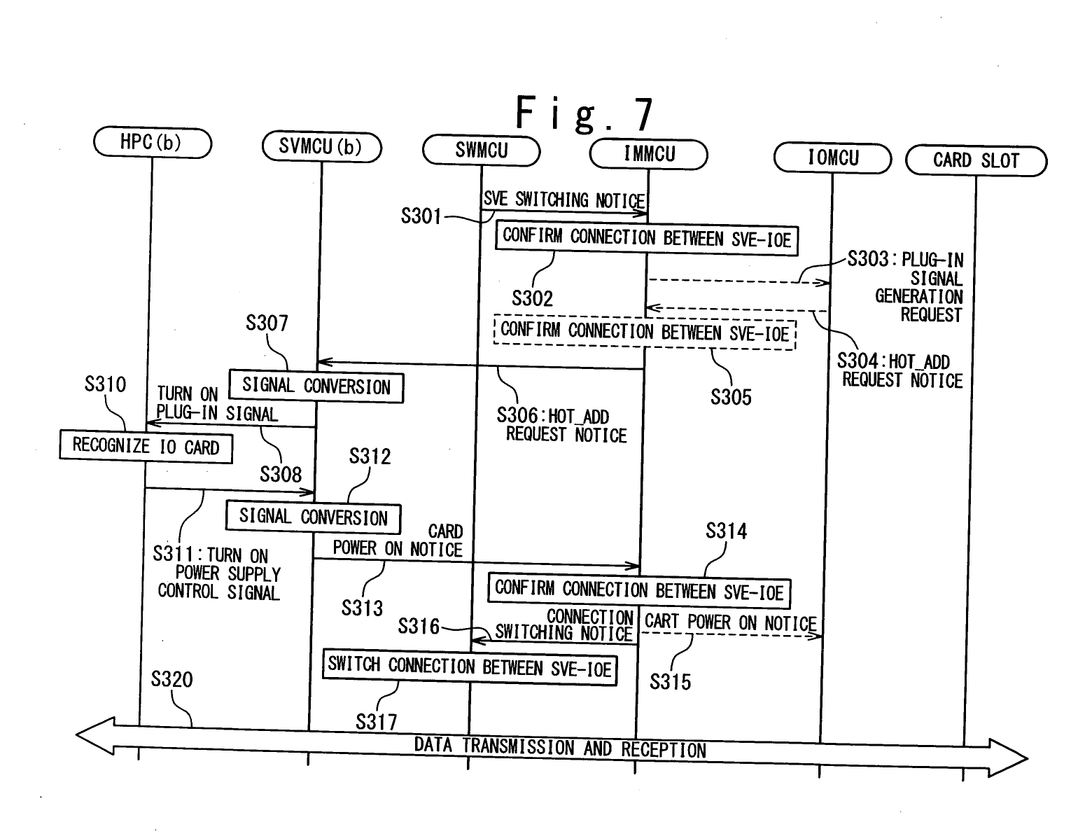

An operation for switching the host equipment in the multi-housing and multi-host information processing system will be described with reference to FIG. 7. When the current operation system and the backup system are switched, a corresponding relation between the concerned I/O card slot 322 and the host equipments 120a and 120b is required to be switched. The I/O card 420 is kept in the mounted state to the concerned I/O card slot 322, and the assertion or deassertion is not performed to a hot plug signal group 328 from the I/O card 420 to the I/O management control unit 321. Therefore, the switching management control unit 221 transmits a host switching notice message for switching from the current operation host equipment 120a to the backup host equipment 120b to an integration management machine control unit 521 (step S301). The integration management machine control unit 521 receives the host switching notice message and confirms a connection relation between the host equipment 120 and the I/O equipment 320 (step S302).

When it is required to notify a connection state with the host equipments 120a and 120b to the I/O equipment 320 side, the integration management machine control unit 521 transmits a plug-in signal generation requesting message for notifying host equipment switching to the I/O management control unit 321 (step S303). This requesting message is a message for instructing the I/O management control unit 321 to operate as if the assertion or deassertion of the hot plug signal group 328 is performed to the hot plug signal group from the I/O card 420. Consequently, the I/O management control unit 321 transmits a Hot-Add request notice message to the integration management machine control unit 521 as if the I/O card 420 is mounted (step S304). The integration management machine control unit 521 confirms the connection relation between the host equipment 120 and the I/O equipment 320 based on the Hot-Add request notice message (step S305). The steps S303 to step S305 are for notifying to the I/O equipment 320 side, and may be omitted if the notification to the I/O equipment 320 side is not required.

When confirmation of a connection state of the host equipment 120b is completed, the integration management machine control unit 521 transmits the Hot-Add request notice message to the host management control unit 121b (step S306). The host management control unit 121b receives the of Hot-Add request notice message, converts the notice message into an electric signal (step S307), asserts a plug-in signal in the hot plug signal group 128b, and transfers it to the hot plug controller 122b (step 3308).

When detecting that the plug-in signal is in assert state, the hot plug controller 122b generates an interrupt for the operating system (OS) through the I/O device controller 124b. The operating system (OS) changes a state of the concerned I/O card slot 322 managed by the hot plug controller 122b into a mounted state, and instructs the hot plug controller 122b to execute power-on (step S310). In response to the instruction from the operating system (OS), the hot plug controller 122b asserts a power control signal for the concerned I/O card slot 302 (step S311) When detecting that the power control signal is asserted, the host management control unit 121b converts it into a card power-on notice message (step S312). The host management control unit 121b notifies the card power-on notice message to the integration management machine control unit 521 (step S313).

The integration management machine control unit 521 receives the card power-on notice message, and confirms a connection relation between the host equipment 120b and the I/O equipment 320 (step S314). The integration management machine control unit 521 transmits a connection switching notice message to the switching management control unit 201 on the basis of the confirmed connection relation (step S316). The switching management-control unit 221 receives the connection switching notice message, performs connection control of the switching mechanism 222 and validates a connection between the concerned I/O card slot 322 and the host equipment 120b (step S317). Therefore, the bus 129b and the bus 329 are connected to each other. Subsequently, data transmission and reception are carried out between the I/O card 420 and the host equipment 120b through the switching equipment 220 (step S320). In addition, the integration management machine control unit 521 may transmit the card power-on notice message to the I/O management control unit 321 (step S315).

As described above, an integration management machine 520 can forcibly assert and deassert a hot plug signal group by instructing the host management control unit 121b and the I/O management control unit 321. At this time, the hot plug signal group 328 does not change for the concerned I/O card slot 322 and the I/O card 420. As described above, an appropriate hot plug process in the multi-housing and multi-host system can be easily realized.

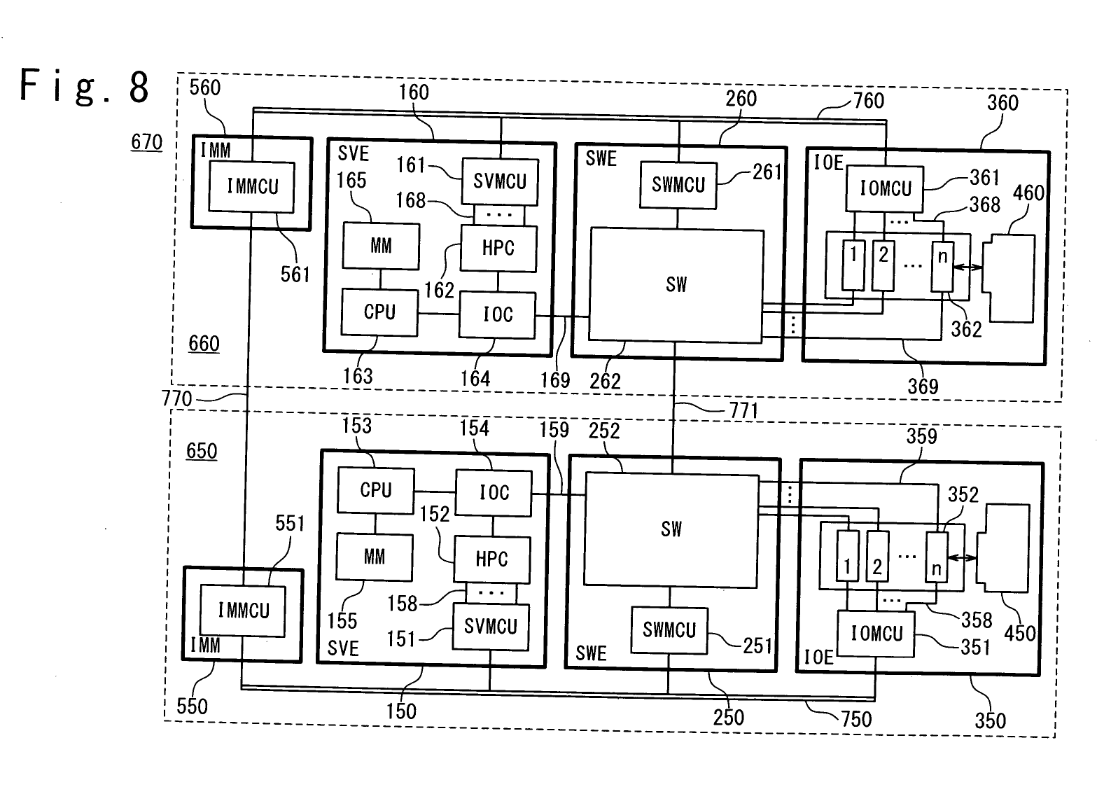

Next, referring to FIG. 8, a multi-housing information processing system according to the fourth exemplary embodiment of the present invention will be described. A multi-housing information processing system 670 includes sub systems 650 and 660. The subsystems 650 and 660 have the same configuration as the multi-housing information processing system shown in FIG. 1.

The subsystem 650 includes a host equipment 150, a switching equipment 250, an I/O equipment 350, and an integration management machine 550, which are produced in different housings. These equipments are connected to each other by a LAN 750. The host equipment 150 includes a CPU 153, a host management control unit 151, a memory 155, an I/O controller 154, and a hot plug controller 152. The switching equipment 250 includes a switching management control unit 251 and a switching mechanism 252. The I/O equipment 350 includes a card slot section having I/O card slots 352-1 to 352-n and an I/O management control unit 351.

A subsystem 660 includes a host equipment 160, a switching equipment 260, an I/O equipment 360, and an integration management equipment 560, which are produced in different housings. These equipments are connected to each other by a LAN 760. The host equipment 160 includes a CPU 163, a host management control unit 161, a memory 165, an I/O controller 164, and a hot plug controller 162. The switching equipment 260 includes a switching management control unit 261 and a switching mechanism 262. The I/O equipment 360 includes a card slot section having I/O card slots 362-1 to 362-n and an I/O management control unit 361.

The integration management machine control unit 551 and the integration management machine control unit 561 are connected to each other by a LAN 770. In addition, for exchanging of data, a switching mechanism 252 and a switching mechanism 262 are connected to each other by a LAN 771. That is to say, the LANs 750, 760, and 770 are interfaces for equipment management, and the LAN 771 is an interface when the operating system (OS) uses an I/O card. The LANs 770 and 771 are interfaces between the subsystems, and the LANs 750 and 760 are interfaces between equipments. The LANs 770, 771, 750 and 760 are exemplarily shown but other interfaces may be used.

A Hot-Plug operation in the present exemplary embodiment is mainly separated in two types. One is a Hot-Plug operation which is closed in the subsystem. That is a case where the I/O card slots 352-1 to 352-n are connected to the host equipment 150 and where the I/O card slots 362-1 to 362-n are connected to the host equipment 160. The Hot-Plug operation in this case is closed in each subsystems, and is the same as that of the first exemplary embodiment shown in FIGS. 1, 2, and 3. The other is a Hot-Plug operation over the subsystems. That is a case where any of the I/O card slots 362-1 to 362-n is connected to the host equipment 150 and where any of the I/O card slots 352-1 to 352-n is connected to the host equipment 160.

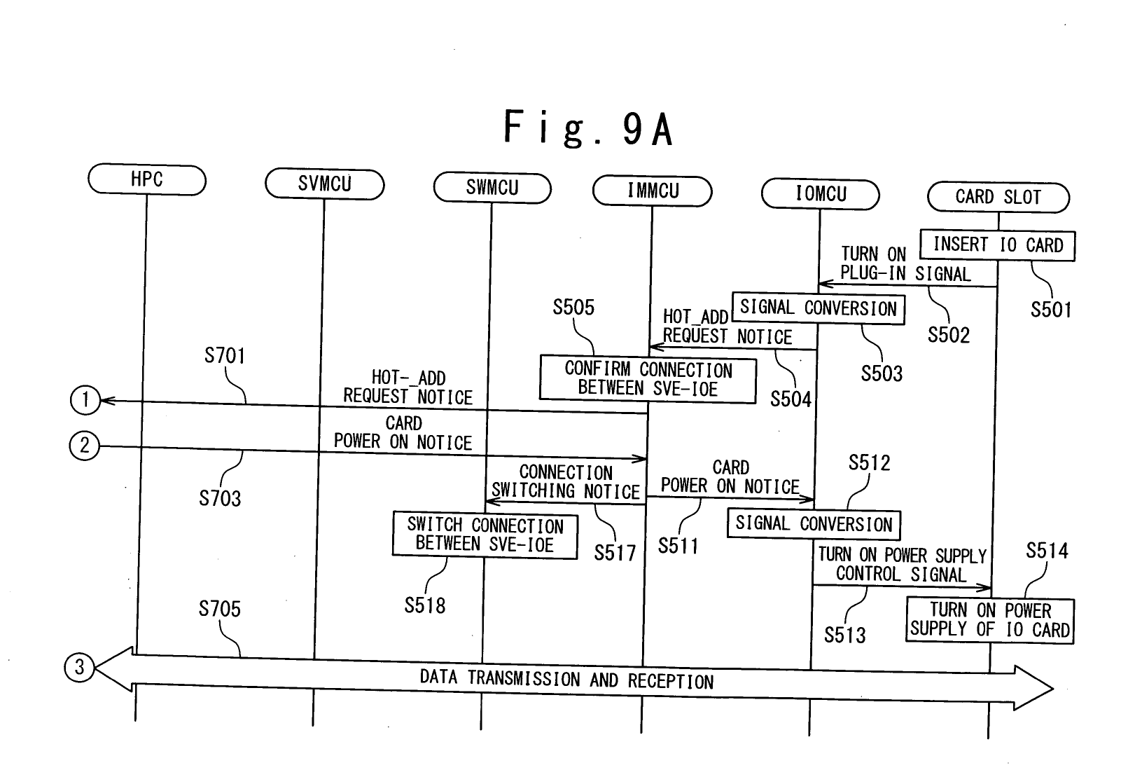

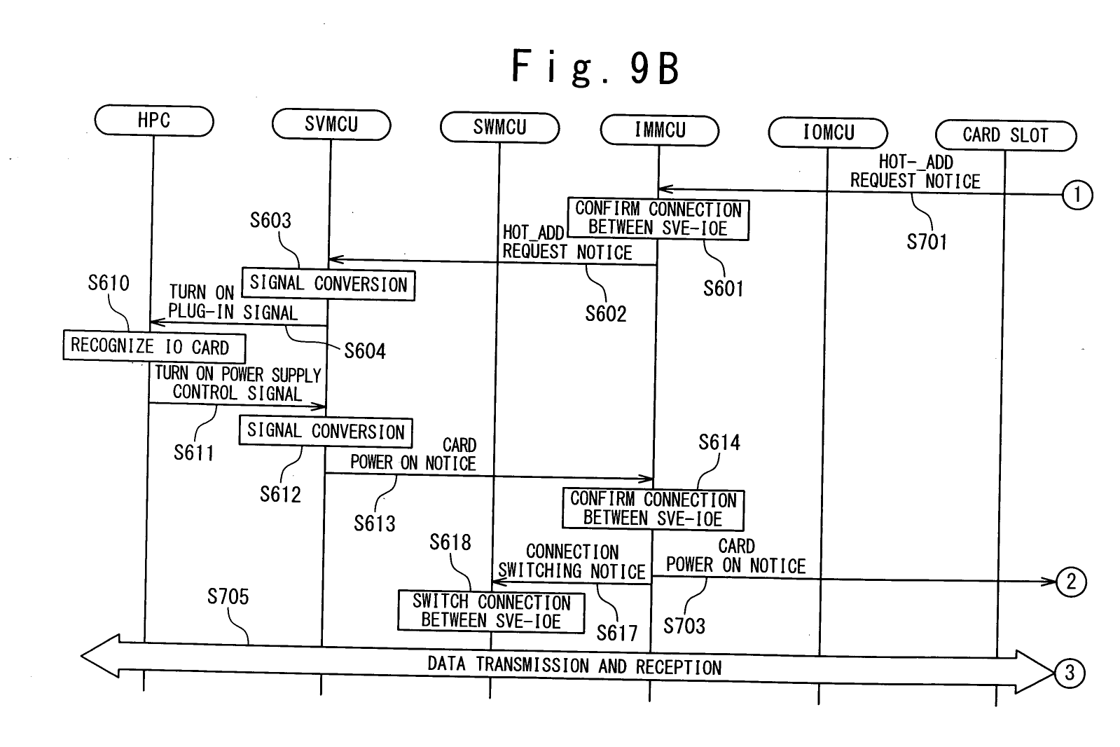

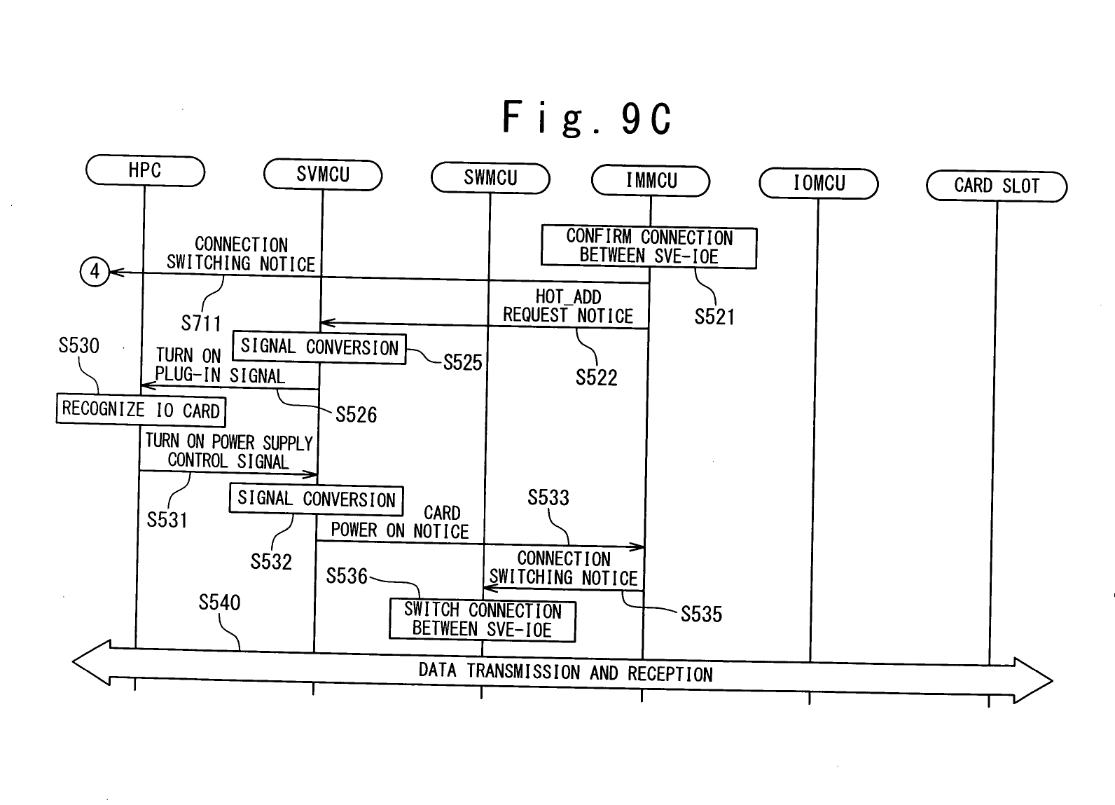

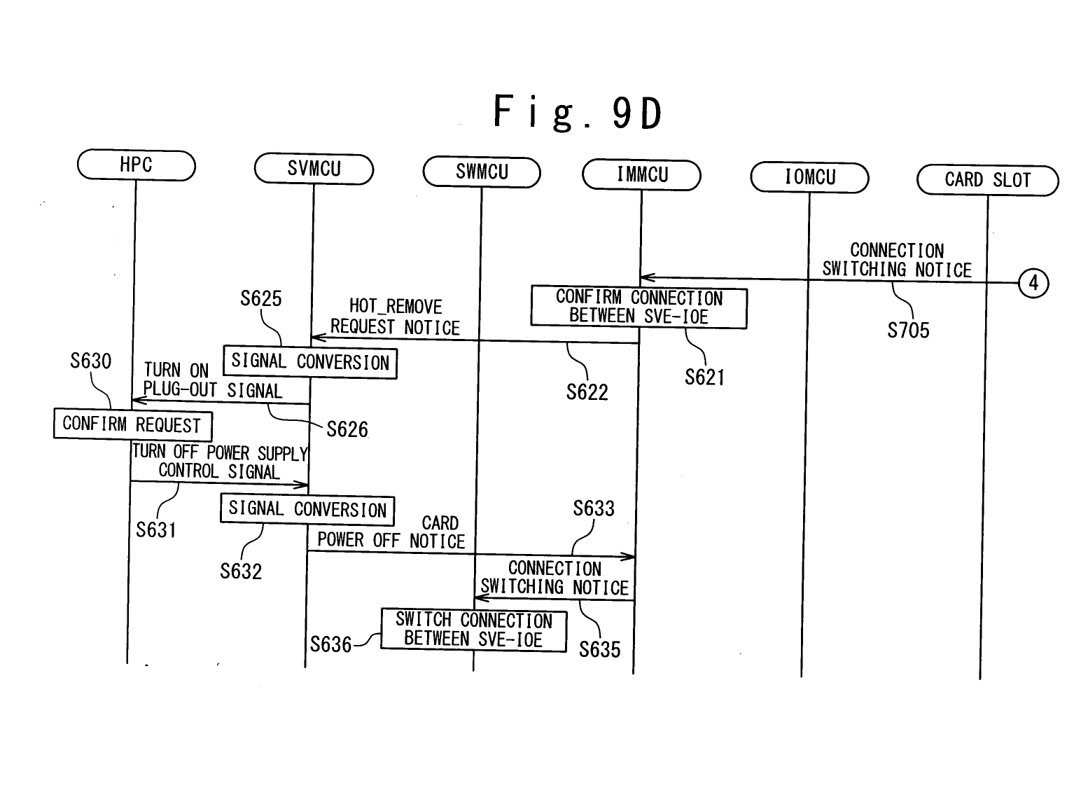

Referring to FIGS. 9A to 9D, the Hot-Plug operation over the subsystems will be described. A hot-Add operation in a case where the I/O card 450 is inserted into the concerned card slot 352 connected to the host equipment 160 will be described with reference to FIGS. 9A and 9B. FIG. 9A shows an operation of the subsystem 650 side and FIG. 9B shows an operation of the subsystem 660 side.

The I/O card 450 is mounted on the concerned I/O card slot 352 of the subsystem 550 (step S501; FIG. 9A), and a plug-in signal in the hot plug signal group 358 is asserted (step S502). The I/O management control unit 351 detects that the plug-in signal is asserted and converts it into a Hot-Add request notice message (step S503). The I/O management control unit 351 transmits the Hot-Add request notice message to the integration management machine control unit 551 through the LAN 750.

The integration management machine control unit 551 received the Hot-Add request notice message, confirms a connection relation between the host equipment 160 and the I/O equipment 350 based on a position indicating a concerned card slot mounted with the I/O card 450 and added to the message (step S505). The integration management machine control unit 551 transmits the Hot-Add request notice message to the integration management machine control unit 561 of the subsystem 660 through the LAN 770 (S701; connection No. 1).

The integration management machine control unit 561 receives the Hot-Add request notice message, and confirms the connection relation between the host equipment 160 and the I/O equipment 350 (step S601; FIG. 9B). The integration management machine control unit 561 transmits the Hot-Add request notice message to the host management control unit 161 through the LAN 760 (step S602).

The host management control unit 101 receives the Hot-Add request notice message, converts the Hot-Add request notice message of into an electric signal (step S603), asserts a plug-in signal of the hot plug signal group 168, and transmits it to the hot plug controller 162 (step S604). When detecting that the plug-in signal is in assert state, the hot plug controller 162 generates an interrupt for the operating system (OS) through the I/O device controller 164.

The operating system (OS) changes a state of the concerned I/O card slot 352 managed by the hot plug controller 162 into a state in which the I/O card 450 is mounted. The operating system (OS) instructs the hot plug controller 162 through the I/O controller 164 to turn on power of the I/O card 450 mounted on the concerned I/O card slot 352 (step S610). In response to the instruction from the operating system (OS), the hot plug controller 162 asserts a power control signal for the concerned I/O card slot 352 (step S611).

When detecting that the hot plug controller 162 has asserted the power control signal, the host management control unit 161 converts it into a card power-on notice message of (step S612). The host management control unit 161 informs the card power-on notice message to the integration management machine control unit 561 through the LAN 760 (step S613).

The integration management machine control unit 561 receives the card power-on notice message, and confirms the connection relation between the host equipment 160 and the I/O equipment 350 (step S614). The integration management machine control unit 561 transfers the card power-on notice message to the integration management machine control unit 551 of the subsystem 650 through the LAN 770 (step S703; connection No. 2). The integration management machine control unit 561 transfers a connection switching notice message to the switching management control unit 261 on the basis of the confirmed connection relation (step S617). The switching management control unit 261 receives the connection switching notice message, performs a connection control of the switching mechanism 262, and validate a connection between the concerned I/O card slot 352 and the host equipment 160 (step S618).

On the other hand, the integration management machine control unit 551 receives the card power-on notice message, transmits the card power-on notice message to the I/O management control unit 351 through the LAN 750 (step S511; FIG. 9A). The integration management machine control unit 551 transmits the connection switching notice message to the switching management control unit 251 (step S517). The switching management control unit 251 receives the connection switching notice message, performs a connection control of the switching mechanism 252, and validates a connection between the concerned I/O card slot 352 and the host equipment 160 (step S518). That is to say, the switching mechanism 252 and the switching mechanism 262 are connected through the LAN 771, to allow the CPU 163 to utilize the I/O card 450.

The I/O management control unit 351 receives the card power-on notice message through the LAN 750 that is an interface for equipment management, converts the card power-on notice message into a power control signal of the hot plug signal group 358 (step S512), asserts the power control signal, and transmits it to the concerned I/O card slot 352 (step S513). Power of the I/O card 450 is turned on and access from the host equipment 160 is made possible (step S514). That is to say, the bus 359 and the bus 169 are connected through the LAN 771 that is an interface for data transmission. Subsequently, data transmission and reception between the host 160 and the I/O card 450 are carried out through the switching equipment 250, the switching equipment 260, and the LAN 771 (step S705; connection No. 3).

An operation when a connection of the I/O card 450 mounted on the concerned I/O card slot 352 is switched to the host equipment 150 while the data transmission and reception is carried out will be described with reference to FIGS. 9C and 9D. FIG. 9C shows an operation of the subsystem 650 side and FIG. 9D shows an operation of the subsystem 660 side.

When a connection change is instructed, the integration management machine control unit 551 confirms a connection relation of the I/O card 450, the host equipment 150, and the host equipment 160 (step S521). The integration management machine control unit 551 transmits the connection switching notice message to the integration management machine control unit 561 of the subsystem 660 (step S711; connection No. 4). A Hot-Add request notice message of is transmitted to the host management control unit 151 of the host equipment 150 connected to the I/O card 450 through the connection change (step S522).

The host management control unit 151 receives the Hot-Add request notice message, converts the Hot-Add request notice message into an electric signal (step S525), asserts a plug-in signal of the hot plug signal group 158, and transmits it to the hot plug controller 152 (step S526). When detecting that the plug-in signal is in the assert state, the hot plug controller 152 generates an interrupt for the operating system (OS) through the I/O device controller 154.

The operating system (OS) changes a state of the concerned I/O card slot 352 managed by the hot plug controller 152 into a state in which the I/O card 450 is mounted. The operating system (OS) instructs the hot plug controller 152 through the I/O device controller 154 to turn on power of the I/O card 450 mounted on the concerned I/O card slot 352 (step S530). In response to the instruction from the operating system (OS), the hot plug controller 152 asserts a power control signal for the concerned I/O card slot 352 (step S531).

When detecting that the hot plug controller 152 asserts the power control signal, the host management control unit 151 converts it into a card power-on notice message of (step S532). The host management control unit 151 informs the card power-on notice message to the integration management machine control unit 551 through the LAN 750 (step S533).

The integration management machine control unit 551 receives the card power-on notice message, confirms a connection relation between the host equipment 150 and the I/O equipment 350, and transmits a connection switching notice message to the switching management control unit 251 (step S535). Since the I/O card 450 is already mounted and accessed by the host equipment 160, it is not required to turn power on anew. Therefore, the card power-on notice message is not transmitted to the I/O management control unit 351. The switching management control unit 251 receives the connection switching notice message, performs a connection control of the switching mechanism 252, and validates a connection between the concerned I/O card slot 352 and the host device 150 (step S536). Subsequently, data transmission and reception are carried out between the I/O card 450 and the host equipment 150 through the switching equipment 250 (step S540).

The integration management machine control unit 561 receives the connection switching notice message, and confirms the connection relation between the host equipment 160 and the I/O equipment 350 (step S621; FIG. 9D). The integration management machine control unit 561 transmits a Hot-Remove request notice message to the host management control unit 161 (step S622). The host management control unit 161 converts the Hot-Remove request notice message into an electric signal (step S625), and asserts a plug-out signal of the hot plug signal group 168 (step S626). When detecting that the plug-out signal is in the assert state, the hot plug controller 162 generates an interrupt for the operating system (OS) through the I/O controller 104.

The operating system (OS) changes a state of the concerned I/O card slot 352 managed by the hot plug controller 162 into a state in which an I/O card is removed and instructs the hot plug controller 162 through the I/O device controller 164 to turn off power of the I/O card 450 (step S630). In response to the instruction from the operating system (OS), the hot plug controller 162 deasserts the power control signal to the concerned I/O card slot 352 (step S631).

When detecting that the hot plug controller 162 has deasserted the power control signal, the host management control unit 161 generates a card power-off notice message (step S632). The host management control unit 161 informs the card power-off notice message to the integration management machine control unit 561 through the LAN 760 (step S633).

The integration management machine control unit 561 receives the card power-off notice message, confirms the connection relation between the host equipment 160 and the I/O equipment 350, and transmits the connection switching notice message to the switching management control unit 261 (step S635). The switching management control unit 261 receives the connection switching notice message, performs connection control of the switching mechanism 262, and invalidates a connection with the switching mechanism 252 (step S636).

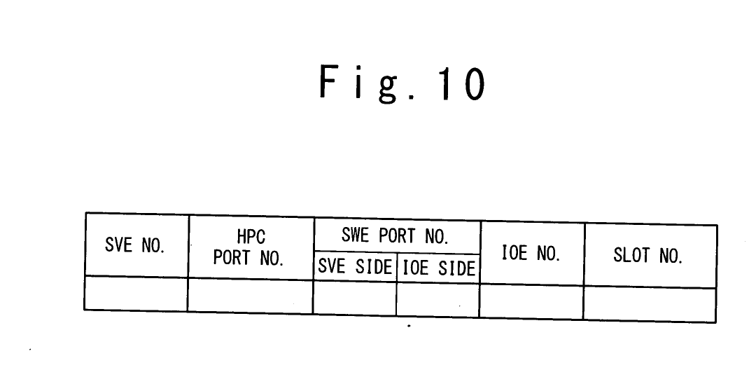

As described above, an equipment which transmits a hot plug signal group can be switched based on a system configuration. As configuration data of this system, a table indicating a connecting state between equipments may be included, as shown in FIG. 10. Data indicating how the switching equipment (SWE) is connected to the host equipment, and how an I/O card slot is built in an I/O equipment (IOE) and connected to the switching equipment are related to connection ports of the switching equipment. Furthermore, data indicating types of mounted I/O cards and its operating condition may be stored.

Here, a system in which the integration management equipment is provided in an independent housing has been described. However, for example, a function may be installed on a switching management section of the switching equipment. In addition, a function of the switching management section may be transferred from the switching equipment to the integration management equipment in order to manage a configuration of the system. Furthermore, a hot plug signal group and messages transmitted or received between respective management sections are not restricted to those described above.

As described above, according to the exemplary embodiment of the present invention, since it is possible to control transmission of a hot plug signal between a host equipment and an I/O equipment from an external unit other than a part/equipment for the hot plug, e.g., the integration management equipment, an arbitrary hot plug process suitable for a configuration of a system can be realized. That is to say, in a multi-host system in which one I/O is switched and used by a plurality of hosts, a pseudo hot plug signal which is not generated usually can be generated by instructing to assert the hot plug signal from the external unit upon the host switching.

In a multi-housing information processing system having multiplexed switches, transmission of the hot plug signal to an I/O can be avoided by discarding a occurrence notice of a hot plug event and by not performing a Hot-plug in a switch failure in which a redundant path is used to continue the operation.

According to the exemplary embodiments of the present invention, in a multi-housing and multi-host system, a physical wiring of the hot plug signal is not required and complicated configuration for switching a signal is not needed. Therefore, hardware configuration can be simple and the system can be configured in a low cost.

According to the present invention, a multi-housing device which performs an arbitrary hot plug process adapted to a system configuration. In addition, according to the present invention, a low price multi-housing device can be provided since a complicated configuration for switching hot plug signals is unnecessary.

Although the inventions has been described above in connection with several preferred embodiments thereof, it will be appreciated by those skilled in the art that those embodiments are provided solely for illustrating the invention, and should not be relied upon to construe the appended claims in a limiting sense.

What is claimed is:

1. An information processing system comprising:
an I/O equipment configured to allow an I/O card to be mounted or removed in an operation, to control said I/O card based on a control message, and to generate a state message indicating a state of said I/O card;
a control equipment configured to output said control message to said I/O equipment in response to said state message; and
a relay equipment configured to relay said control message and said state message based on a configuration data indicating a connection relation between said I/O equipment and said control equipment.

2. The information processing system according to claim 1, wherein said I/O equipment comprises:
an I/O card slot section comprising I/O card slots, for one of which said I/O card is mounted, and configured to generate a state hot plug signal; and
an I/O converting section configured to convert said state hot plug signal into said state message, and to reproduce a control hot plug signal for controlling said I/O card based on said control message,
said control equipment comprises:
a control converting section configured to reproduce said state hot plug signal based on said state message; and
a hot plug controller configured to generate said control hot plug signal in response to said state hot plug signal.

3. The information processing system according to claim 1, further comprising:
a switch equipment configured to switch a connection between said I/O equipment and said control equipment, and
wherein when said switch equipment changes the connection between said I/O equipment and said control equipment, said relay equipment generates and deletes the control message and the state message based on said configuration data.

4. The information processing system according to claim 3, wherein said control equipment and said I/O equipment are connected through one of a plurality of said switch equipments, and
said relay equipment switches the connection between said I/O equipment and said control equipment the connection between said I/O equipment and said control equipment from said one switch equipment to another without relaying the control message and the state message based on based on said configuration data.

5. The information processing system according to claim 3, wherein said switch equipment is connected with a plurality of said control equipments, and
when said switch equipment switches connection of said I/O equipment from one of said plurality of control equipments to another, said relay equipment generates the state message to said another control equipment based on said configuration data.

6. The information processing system according to claim 3, wherein said switch equipment is connected with a plurality of said I/O equipments, and
when said switch equipment switches connection of said control equipment from one of said plurality of I/O equipments to another, said relay equipment generates the state message to said control equipment based on said configuration data.

7. The information processing system according to claim 4, wherein said switch equipment is connected with a plurality of said control equipments, and
when said switch equipment switches connection of said I/O equipment from one of said plurality of control equipments to another, said relay equipment generates the state message to said another control equipment based on said configuration data.

8. The information processing system according to claim 4, wherein said switch equipment is connected with a plurality of said I/O equipments, and
when said switch equipment switches connection of said control equipment from one of said plurality of I/O equipments to another, said relay equipment generates the state message to said control equipment based on said configuration data.

9. The information processing system according to claim 5, wherein said switch equipment is connected with a plurality of said I/O equipments, and
when said switch equipment switches connection of said control equipment from one of said plurality of I/O equipments to another, said relay equipment generates the state message to said control equipment based on said configuration data.

10. The information processing system according to claim 3, wherein said I/O equipment, said control equipment, said relay equipment and said switch equipment are provided in different housings, respectively.

11. A connecting method in an information processing system which comprises an I/O equipment configured to allow an I/O card to be mounted or removed in an operation, and a control equipment configured to control said I/O card, said connecting method comprising:
generating a state message indicating a state of said I/O card;
relaying said state message to said control equipment based on a configuration data indicating a connection between said I/O equipment and said control equipment;
generating a control message indicating a control signal for said I/O card based on said state message; and
relaying said control message to I/O equipment based on said configuration data.

12. The connecting method according to claim 11, wherein said generating a state message comprises:
converting a state hot plug signal indicating a state of said I/O card into said state message,
said generating a control message comprises:
reproducing said state hot plug signal from said state message;
generating a control hot plug signal from the reproduced state hot plug signal; and
converting said control hot plug signal into said control message.

13. The connecting method according to claim 11, wherein said I/O equipment and said control equipment are connected through a switch equipment,
said connecting method further comprises:
changing a connection between said I/O card and said control equipment,
said relaying said state message comprises:
generating or deleting said state message based on said configuration data, and
said relaying said control message comprises:
generating or deleting said control message based on said configuration data.

14. The connecting method according to claim 13, wherein said I/O equipment and said control equipment are connected through one of a plurality of said switch equipments,
said connecting method further comprises:
changing a connection path between said I/O card and said control equipment, and
each of said relaying said state message and said relaying said control message comprises:
deleting said state message and said control message.

15. The connecting method according to claim 13, wherein said I/O equipment and one of a plurality of said control equipments are connected,
said connecting method further comprises:
changing a target control equipment to be connected with said I/O card among said plurality of control equipments, and
said relaying said state message comprises:
generating said state message to said target control equipment based on said configuration data.

16. The connecting method according to claim 13, wherein said switch equipment is connected with one of plurality of said I/O equipments,
said connecting method further comprises:
changing a target I/O equipment to be connected with said control equipment among said plurality of I/O equipments, and
said relaying said state message comprises:
generating said state message to said control equipment based on said configuration data.

17. An information processing system comprising:
a network;
an I/O equipment connected with said network, and configured to allow an I/O card to be mounted or removed in an operation, to control said I/O card based on a control message, and to generate a state message indicating a state of said I/O card;
a control equipment connected with said network, and configured to output said control message to said I/O equipment in response to said state message; and
a relay equipment connected with said network, and configured to relay said control message and said state message based on a configuration data indicating a connection relation between said I/O equipment and said control equipment.

18. The information processing system according to claim 17, wherein said I/O equipment comprises:
an I/O card slot section comprising I/O card slots, for one of which said I/O card is mounted, and configured to generate a state hot plug signal; and
an I/O converting section configured to convert said state hot plug signal into said state message, and to reproduce a control hot plug signal for controlling said I/O card based on said control message,
said control equipment comprises:
a control converting section configured to reproduce said state hot plug signal based on said state message; and
a hot plug controller configured to generate said control hot plug signal in response to said state hot plug signal.

19. The information processing system according to claim 17, further comprising:
a switch equipment connected with said network, and configured to switch a connection between said I/O equipment and said control equipment, and
wherein when said switch equipment changes the connection between said I/O equipment and said control equipment, said relay equipment generates and deletes the control message and the state message based on said configuration data.
